(19) United States
(12) Patent Application Publication
(10) Pub. No.: US 2002/0124456 A1
(43) Pub. Date: Sep. 12, 2002

(54) Fish hook with pivoted auxiliary barb

(76) Inventor: George Mendoza, Bend, OR (US)

Correspondence Address: Glenn C. Brown, MARGER JOHNSON McCOLLOM, P.C., 1030 S.W. Morrison Street, Portland, OR, 97205, US

(21) Appl. No.: 09/782,958

(22) Filed: Feb. 12, 2001

Related U.S. Application Data
(63) Continuation-in-part of application No. 09/270,809, filed on Mar. 17, 1999, now abandoned.

(51) Int. Cl. A01K 83/06

(52) U.S. Cl. 43/44.82

(57) ABSTRACT

A fishhook with a shank having a first end and a second end, the first end having an eyelet, the second end having a generally u-shaped portion with a pointed distal end. An operable member has a first end that is pivotally connected to the shank adjacent the u-shaped portion of the first hook and includes a distal portion with a pointed end extending toward the fish hook first end. The operable member is pivotal between a first position with the distal portion adjacent to the shank and a second position with the distal portion spaced apart from the shank. In one embodiment, a biasing member urges the distal portion of the operable member toward the shank.

### BACKGROUND

1. Field of Invention

The present invention provides an improved fish hook having main and auxiliary barbs with the latter lying alongside the former and pivotally mounted thereon to swing outwardly therfrom to positively engage the mouth of a fish and prevent escape of the fish.

2. Description of Prior Art

The present invention comprises a fish hook having an auxiliary hook pivoted to the shank of a main hook near the outer end of the main hook and extending alongside the shank of the main hook to pivot outwardly therefrom, as clearly shown in FIGS. 1 and 3 of the drawings. The prior art of record does not show this structure, and it is submitted that claim 1 and claim 5 clearly distinguish over such art.

The present invention provides a concept wherein second or auxiliary hook is pivotally connected to a first hook adjacent the outer end of the latter so as to pivot oppositely from the devices of prior art. Please note, the terminology of claim 1 which defines the auxiliary hook as being pivotally connected to the shank of the first hook adjacent the outer end of the shank of the first hook and extending along said shank toward the inner end of such shank. This structure is quite the opposite of the showing of the prior art.

### SUMMARY OF INVENTION

The present invention provides a fish hook with a pivoted auxiliary hook that has baarbs for automatically engaging with the opposite side of the fish's mouth from that engaged by the main hook barb. The shank of the auxiliary hook extends along the side of the main hook shank when it is in inoperative position so that it can readily enter the mouth of the striking fish when the fish grabs the bait on the main hook. The auxiliary hook has barbs for engaging with the fish's mouth so as to swing the auxiliary hook into open or operative position where its barbs with engage with the adjacent mouth portion of the fish and prevent the disengagement of the hook from the fish. My fish hook therefore has a plurality of barbs that quickly become widely spaced in the fish's mouth when the fish strikes and this prevents the main hook from pulling free from the fish.

### BRIEF DESCRIPTION OF DRAWINGS

FIG. 1 is a side elevation of a fish hook in accordance with the present invention showing the pivoted auxiliary hook in closed position.

FIG. 2 illustrates the fish hook partially in section to show the structure that prevents any further swinging of the auxiliary hook in the same direction when it once reaches its full open position.

FIG. 3 is a view similar to FIG. 1, showing the pivoted auxiliary hook swung into open position so as to move its barbs farther away from the main hook barb.

FIG. 4 is a transverse section taken along the line 4-4 of FIG. 3.

FIG. 5 is an illustration of the fish hook with its barbs engaging with opposite sides of the fish's mouth.

### DESCRIPTION OF PREFERRED EMBODIMENTS

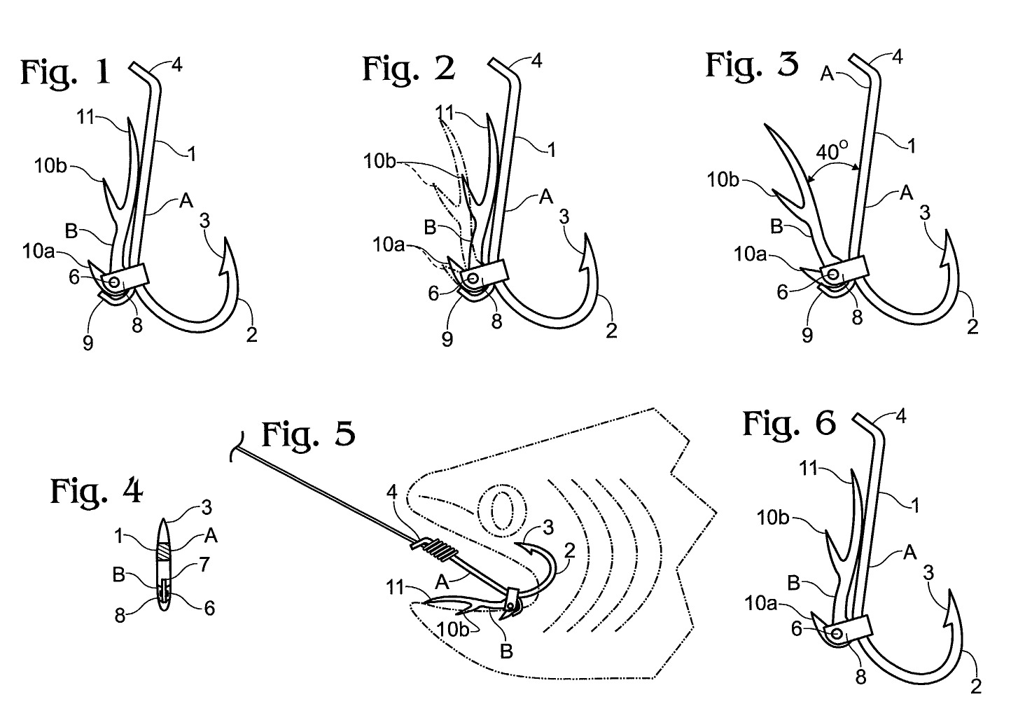

In carrying out my invention I provide a fish hook A, as shown in FIGS. 1 and 3, that has a main shank 1, a curved portion 2 extending from the outer end of the shank and a barb 3 at the end of the curved portion. The fish hook may be made from any desired material and may be of any size. The shank 1 has an eyelet 4 at the inner end thereof to which a fish line 5 is secures, see FIG. 5.

An auxiliary hook B, has one end pivoted to the outer end of the main shank 1 at 6, see FIGS. 1 to 3 inclusive. The shank 1 has a recess 7 adjacent to the pivot pin 6 so that the shank is U-shaped in cross-section at this point, see FIG. 4. The side walls of the U-shaped portion are provided with integral ears 8 that straddle the pivoted end of the auxiliary hook B, and receive the pivot pin 6 which also extends through the hook B. The ears 8 preferably frictionally contact the sides of the hook B that is received there between for frictionally holding the auxiliary hook in closed position as shown in FIG. 1.

The shape of the auxiliary hook B is curved so as to conform to the shape of the main shank 1 of the fish hook A when the hook B is swung into closed position, see FIG. 1. Two barbs 10a and 10b project from the auxiliary hook B and face away from the shank 1 of the main hook A. The free end of the hook B is formed into a barb.

When using the fish hook A, the barb 3 is baited with the desired fish bait and the auxiliary hook B is retained in the closed position shown in FIG. 1. The hook A is attached to the fish line 5 and the fisherman casts the baited hook into the water. In FIG. 5, I illustrate how the auxiliary hook B functions when a fish C strikes and the hook A enter the mouth. Any pull of the fish on the hook will drive the barb 3 into its mouth. At the same time, the barbs 10a and 10b of the auxiliary hook B will be forced into the fish's mouth and will cause the hook B to swing into open position as shown in FIG. 3 and 5.

It should be noted at this time that the end of the auxiliary hook B which is adjacent to the pivot pin 6 has a flattened portion 12 which swings into contact with the web portion of the recess 7 in the shank 1 of the main hook A, see FIG. 2, and this will prevent the hook B from swinging outwardly any farther than, that shown in FIG. 3. When the auxiliary hook B is in open or operative position as shown in FIG. 5, the barbs 10a and 10b and 11 of the hook B will embed themselves in the fish's mouth and the barb 3 of the main hook and the barb 11 of the hook B will prevent the fish from disengaging the fish hook from its mouth. My fish hook has three barbs 10a, 10b, and 11 of the auxiliary hook B, engaging with the mouth of the fish in addition to the single barb 3 mounted at the end of the curved portion 2 of the main shank 1. This type of fish hook with its auxiliary hook B, will double the chances of catching a fish. I have created two hooks instead of one.

In another embodiment shown in FIG. 6, the pivoted auxiliary barb B is pivotally mounted on bracket 8 as with the earlier described embodiment. In this embodiment, however, the spring 9 is omitted. Recall that spring 9 biased the auxiliary barb B toward shank 1. In this embodiment, the engagement of the auxiliary barb with the mouth of the fish is relied upon to extend the auxiliary barb. In every other way, the auxiliary barb of this embodiment operates in the same manner.

1. A fish hook assembly comprising:
a fish hook with a shank having a first end and a second end, the first end having an eyelet, the second end having a generally u-shaped portion with a pointed distal end;
an operable member having a first end pivotably connected to the shank adjacent the unshaped portion of the first hook and having a distal portion with a pointed end extending toward the fish hook first end;
the operable member pivotable between a first position with the distal portion adjacent to the shank and a second position with the distal portion spaced apart from the shank; and
a biasing member urging the distal portion of the operable member toward the shank.

2. A fish hook according to claim 6 wherein the biasing member consists of a curved spring bearing on the operable member.

3. A fishhook according to claim 6 wherein the operable member is operable to the second position responsive to engagement with the mouth of a fish.

4. A fishhook according to claim 6 wherein the operable member includes at least one pointed portion.

5. A fish hook according to claim 6 wherein the operable member includes a second pointed portion.

6. A fish hook assembly comprising:
a fish hook with a shank having a first end and a second end, the first end having an eyelet, the second end having a generally u-shaped portion with a pointed distal end;
an operable member having a first end pivotably connected to the shank adjacent the u-shaped portion of the first hook and having a distal portion with a pointed end extending toward the fish hook first end; and,
the operable member pivotable between a first position with the distal portion adjacent to the shank and a second position with the distal portion spaced apart from the shank.

7. A fish hook according to claim 6 wherein the biasing member consists of a curved spring bearing on the operable member.

8. A fishhook according to claim 6 wherein the operable member is operable to the second position responsive to engagement with the mouth of a fish.

9. A fishhook according to claim 6 wherein the operable member includes at least one pointed portion.

10. A fish hook according to claim 6 wherein the operable member includes a second pointed portion.
